(19) United States
(12) Patent Application Publication
(10) Pub. No.: US 2025/0107522 A1
(43) Pub. Date: Apr. 3, 2025

(54) BIOMOLECULAR MATERIAL AND RELATED METHODS

(71) Applicant: BATTELLE SAVANNAH RIVER ALLIANCE, LLC, AIKEN, SC (US)

(72) Inventors: ALEX J. KUGLER, RICHLAND, WA (US); CORY L. TRIVELPIECE, AIKEN, SC (US)

(21) Appl. No.: 18/478,133

(22) Filed: Sep. 29, 2023

(51) Int. Cl. A01N 25/08; A01N 43/16; A01P 1/00; C03C 11/00; C03C 17/28

(52) U.S. Cl. CPC A01N 25/08; A01N 43/16; A01P 1/00; C03C 11/00; C03C 17/28; C03C 2218/11; C03C 2218/32

(57) ABSTRACT

The present invention is directed to a biomolecular material and related methods of forming and utilizing such biomolecular material. In one aspect, a biomolecular material includes a porous material and one or more biomolecules. In one aspect, a method for forming a biomolecular material may include applying one or more biomolecules to a porous material and lyophilizing the one or more biomolecules.

### FEDERAL RESEARCH STATEMENT

This invention was made with government support under Contract No. 89303321CEM000080 awarded by the U.S. Department of Energy. The government has certain rights in the invention.

### FIELD

This present subject matter relates generally to a biomolecular material, more particularly, to a biomolecular material including one or more biomolecules.

### BACKGROUND

In recent years, corporate sustainability initiatives and national environmental initiatives have become increasingly prominent and influential. Notably, the waste management of manufacturing processes has become a growing concern as manufacturers adjust their processes to better respond to environmental concerns of the manufacturer itself, the public, and administrative or governmental entities. Particularly, the waste management of glass has become a growing concern in modern times. Indeed, it is estimated that over four million tons of waste glass are disposed of in landfills in the United States each year. As such, various corporate sustainability initiatives have focused on processes involving waste glass material. However, recycling waste glass into practical and serviceable products has proven to be challenging.

Further, in modern times, biomolecules have been utilized in various industries. For instance, biomolecules have been utilized in industries involving agriculture, pharmaceuticals, and environmental remediation. However, the stability of biomolecules is generally dependent on the conditions to which the biomolecules are subjected. For instance, environmental conditions such as temperature, humidity, and pressure may lower the potency and purity of the biomolecules over time, such as when the biomolecules are in storage. In this respect, various conditions may affect the activity of biomolecules, which is a significant property indicative of a biomolecule's ability to perform one or more functions.

Thus, there is a need for an improved biomolecular material, particularly a biomolecular material formed from recycled materials that can be stored for later use, and related methods.

### SUMMARY OF THE INVENTION

Aspects and advantages of the invention will be set forth in part in the following description, or may be obvious from the description, or may be learned through practice of the invention.

In one aspect, the present subject matter is directed to a biomolecular material. The biomolecular material may include: a porous material, the porous material being in the form of a solid, the porous material comprising a surface, wherein at least a portion of the surface of the porous material is a substrate; and one or more biomolecules, wherein the one or more biomolecules are retained on the substrate, wherein at least one of the one or more biomolecules is lyophilized.

In one aspect, the present subject matter is directed to a method for forming a biomolecular material. The method may include: applying one or more biomolecules to a porous material, the porous material being in the form of a solid, the porous material comprising a surface, wherein at least a portion of the surface of the porous material is a substrate; and lyophilizing the one or more biomolecules to form a biomolecular material, wherein the one or more lyophilized biomolecules are retained on the substrate.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to a biomolecular material and related methods. As used herein, a “biomolecular material” refers to a material that comprises one or more biomolecules (e.g., one or more macromolecules and/or one or more micromolecules). The biomolecular material may also comprise a porous material (e.g., a glass-based porous material). The biomolecular material of the present disclosure may have enhanced biomolecular stability and/or activity when compared to traditional biomolecular materials. Further, the biomolecular material of the present disclosure may be advantageously utilized in industries such as the agricultural industry, the pharmaceutical industry, and/or in environmental remediation applications. For instance, in the agricultural industry, a biomolecular material formed in accordance with the present disclosure may be mixed into soil having phosphatase enzymes, which may increase the ability of plants and/or soil microbes to make use of phosphate in the soil. Further, for instance, in environmental remediation applications, a biomolecular material comprising metal binding proteins may be utilized to chelate or capture metals present in a liquid (e.g., a solution).

As used herein, “biomolecule” refers to a molecule comprising one or more chemical moieties that are generally synthesized in and/or by living organisms. For instance, one or more biomolecules may include a carbohydrate, a lipid, a nucleic acid, a protein, or a combination thereof. Further, for instance, one or more biomolecules may include an amino acid, an antibody, an antioxidant, an enzyme, a fatty acid, glucose, glycogen, a coenzyme, collagen, keratin, a pigment, a peptide, a receptor, a retinoid, a transporter, a vitamin, an antibiotic (e.g., an aminoglycoside), or a combination thereof. It should be understood that the one or more biomolecules may comprise a plurality of any of the biomolecules disclosed herein. For instance, one or more biomolecules may include two or more carbohydrates, two or more lipids, two or more nucleic acids, and/or two or more proteins.

In general, a biomolecular material formed in accordance with the present disclosure may include one or more biomolecules that have undergone chemical transformations and/or were purified using advanced manufacturing technologies or genetic engineering.

It should be understood that throughout the entirety of this specification, each numerical value (e.g., weight percentage, concentration) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the endpoints and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

Generally, a biomolecular material formed in accordance with the present disclosure may be utilized for long-term storage, transport, and delivery of a biomolecule in a variety of useful applications. For instance, and without limitation, the biomolecular materials may be formed to include a single or a consortium of biomolecules for deployment to mitigate disasters (e.g., oil spills), remediate legacy contamination (e.g., acid mine drainage), utility applications (e.g., wastewater treatment), agricultural applications (e.g., soil restoration), etc. Moreover, due to the nature of solid biomolecular materials, the biomolecular materials can be easily recovered following use, which may be useful to prevent the release of the biomolecules retained thereon and/or prevent the overuse of the biomolecules at a deployment site. Further, the biomolecular materials may also provide for long shelf life and easy transport to a site without the need for expensive environmental control.

In general, a biomolecular material, including any components thereof may be environmentally friendly, inexpensive, and capable of supporting a biomolecule. As previously disclosed herein, the biomolecular material includes a porous and/or glass-based material (e.g., a glass-based porous material). As such, a lyophilization process may be easier as compared to previously known materials, e.g., unsupported biomolecules and substrates not conducive to biomolecule attachment, activity, and/or stabilization. Moreover, lyophilized biomolecules retained on a substrate need only be placed in a receptive environment for activity to begin, whereas previously known lyophilized biomolecules often require a lengthy growth period in a laboratory for proliferation.

In one aspect, a biomolecular material may include a porous material, such as a natural porous material or a synthetic porous material. In general, a biomolecular material and/or a porous material may be in the form of a solid. In one aspect, the biomolecular material may comprise a glass-based porous material. In this respect, the biomolecular material and/or porous material may comprise a foamed glass, an engineered cellular magmatic, or a combination thereof. Notably, engineered cellular magmatics are distinguishable from foamed glass in that engineered cellular magmatics comprise crystalline components and vitreous components. Generally, engineered cellular magmatics are synthetic materials formed of glass or ceramic, such as recycled glass or recycled ceramic.

Generally, the porous material may comprise a surface. Notably, at least a portion of the surface of a porous material may comprise a substrate. As used herein, the “substrate” of the porous material is the portion of the surface of the porous material to which one or more biomolecules are adhered and/or retained.

Generally, a glass-based porous material may comprise and/or be formed at least partially from a glass composition (e.g., recycled glass, virgin glass). The glass composition may include granulated glass, such as pulverized glass. In this respect, the glass composition may have a selectively chosen average particle size. For instance, the glass composition may have an average particle size of 3000 microns or less, such as 2500 microns or less, such as 2200 microns or less, such as 2000 microns or less, such as 1800 microns or less, such as 1500 microns or less, such as 1200 microns or less, such as 1000 microns or less, such as 800 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The glass composition may have an average particle size of 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 50 microns or more, such as 100 microns or more, such as 200 microns or more, such as 300 microns or more, such as 400 microns or more, such as 500 microns or more, such as 800 microns or more, such as 1000 microns or more, such as 1200 microns or more, such as 1500 microns or more, such as 1800 microns or more, such as 2000 microns or more, such as 2200 microns or more, such as 2500 microns or more. Furthermore, in one aspect, the aforementioned values may refer to a median particle size of the glass composition.

In general, the glass composition may include any suitable glass. For instance, the glass composition may include soda-lime glass, composite glass, glass wool, container glass, fused silica glass, ninety-six percent silica glass, a-glass, flat glass, e-glass, c-glass, ar-glass, s-glass, recycled glass cullet, lead glass, flint glass, borosilicate glass (e.g., single-phase borosilicate glass, phase separated borosilicate glass), aluminosilicate glass, germanium-oxide glass, glass-ceramics, chalcogenide glass, or a combination thereof. In some aspects, a glass composition may include silicon dioxide.

In some aspects, the glass composition may comprise natural pumice or synthetic equivalents, natural obsidian or synthetic equivalents, natural perlite or synthetic equivalents, coal slags, metal slags, smelting slags, mineral wool, or ash byproducts from incineration processes, as well as any combinations thereof.

Generally, a porous material of a biomolecular material formed in accordance with the present disclosure may include a glass composition in conjunction with one or more additional materials, e.g., an amorphous material in conjunction with a secondary material, which can be a crystalline or non-crystalline material, including one or more different glasses. For instance, the porous material may include one or more of alumina, alumina hydrate, aplite, feldspar, nepheline syenite, calumite, kyanite, kaolin, cryolite, antimony oxide, arsenious oxide, barium carbonate, barium oxide, barium sulfate, boric acid, borax, anhydrous borax, quicklime, calcium hydrate, calcium carbonate, dolomitic lime, dolomite, finishing lime, litharge, minium, calcium phosphate, bone ash, iron oxide, caustic potash, saltpeter, potassium carbonate, hydrated potassium carbonate, sand, diatomite, soda ash, sodium nitrate, sodium sulfate, sodium silica-fluoride, pyrolysis ash, zinc oxide, or any combination thereof.

In one aspect, a biomolecular material and/or a porous material of a biomolecular material formed in accordance with the present disclosure may comprise a foaming agent (e.g., a blowing agent). The foaming agent may include physical foaming agents, chemical foaming agents (e.g., carbonaceous materials), or a combination thereof. For instance, in one aspect, the foaming agent may comprise anthracite, aluminum nitride, aluminum slag, activated carbon, activated charcoal, carbon ash, carbon black, calcium carbonate, calcium sulfate, coke, dolomite, fly ash, glycerin, graphite, limestone, magnesium carbonate, manganese oxide, silicon carbide, sodium carbonate, sodium silicate, soot, or a combination thereof.

In one aspect, a biomolecular material and/or a porous material of a biomolecular material formed in accordance with the present disclosure may comprise a glass composition and a foaming agent. In one aspect, a glass-based porous material of a biomolecular material formed in accordance with the present disclosure may comprise a glass composition and a foaming agent. In this respect, in one aspect, the process of forming a porous material of a biomolecular material may include mixing a glass composition and a foaming agent. Then, the resulting mixture of the glass composition and the foaming agent may be heated until the mixture foams into a foamed glass-based material. For instance, the resulting mixture of the glass composition and the foaming agent may be heated in a kiln or an oven at a temperature from about 300° C. to about 1400° C., such as about 300° C. or more, such as about 400° C. or more, such as about 500° C. or more, such as about 600° C. or more, such as about 700° C. or more, such as about 800° C. or more, such as about 900° C. or more, such as about 1000° C. or more, such as about 1100° C. or more, such as about 1200° C. or more, such as about 1300° C. or more, such as about 1400° C. or less, such as about 1300° C. or less, such as about 1200° C. or less, such as about 1100° C. or less, such as about 1000° C. or less, such as about 900° C. or less, such as about 800° C. or less, such as about 700° C. or less, such as about 600° C. or less, such as about 500° C. or less, such as about 400° C. or less. The heating of the mixture of the glass composition and the foaming agent may result in the foaming agent releasing a gas. The release of the gas from the foaming agent may produce a foamed glass-based material. Then, the foamed material may be cooled to form a glass-based porous material. Notably, when an engineered cellular magmatic is produced from a glass composition and a foaming agent, and any other optional additives, the engineered cellular magmatic may be produced at temperatures where the viscosity of the glass composition is from about 1.5 to about 4 orders of magnitude greater than the viscosity of the glass composition at the glass composition's liquidus temperature.

Notably, the composition of a glass-based porous material (e.g., foamed glass, engineered cellular magmatic) can be controlled during pre-firing batching, and the physical properties of the materials can be controlled via chemical composition of the batch in addition to process parameters as described further in U.S. Patent Application Publications 2022/0073416, 2022/0081349, and 2022/0089476 all to Hust et al., which are incorporated herein by reference in their entirety. In some embodiments, a glass-based porous material can be formed to include one or more reaction agents that can interact with one or more substances when those substances contact the reaction agents, such as cementitious materials, pozzolanic materials, activated carbon, and/or clayey or zeolitic minerals.

Generally, a biomolecular material and/or a porous material (e.g., a glass-based porous material) of a biomolecular material may have an open-celled porosity, i.e., individual pieces of the biomolecular material and/or porous material may include passageways extending from an external surface of the piece to the interior and/or to a second external surface of the piece. Notably, the porosity of a biomolecular material and/or a porous material of a biomolecular material may provide a high surface area for supporting a selectively chosen density (e.g., high density) of biomolecules thereon. In general, the average pore size of a biomolecular material and/or a porous material of a biomolecular material may be 3000 microns or less, such as 2500 microns or less, such as 2200 microns or less, such as 2000 microns or less, such as 1800 microns or less, such as 1500 microns or less, such as 1200 microns or less, such as 1000 microns or less, such as 800 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. In general, the average pore size of a biomolecular material and/or a porous material of a biomolecular material may be 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 50 microns or more, such as 100 microns or more, such as 200 microns or more, such as 300 microns or more, such as 400 microns or more, such as 500 microns or more, such as 800 microns or more, such as 1000 microns or more, such as 1200 microns or more, such as 1500 microns or more, such as 1800 microns or more, such as 2000 microns or more, such as 2200 microns or more, such as 2500 microns or more. However, in some aspects, the average pore size of a biomolecular material and/or a porous material of a biomolecular material may be even larger.

In some aspects, a biomolecular material and/or a porous material of a biomolecular material may have a single, well-defined porosity. For instance, a biomolecular material and/or a porous material of a biomolecular material may have a single composition with highly homogenous and/or uniform properties, e.g., a single density and a single porosity. In other aspects, a more complex material may be utilized. For instance, a biomolecular material and/or a porous material of a biomolecular material may include vitreous materials contained at least partially within pores of the biomolecular material and/or the porous material of the biomolecular material, leading to regions of the biomolecular material and/or the porous material of the biomolecular material that are mesoporous (i.e., less than about 100 micrometers in cross-section) and/or microporous (i.e., less than about 1 micrometer in cross-section).

In general, a biomolecule may be present on a selectively chosen amount of surface area of a biomolecular material and/or a porous material of a biomolecular material. In one aspect, a biomolecule may form a coating on a biomolecular material and/or a porous material of a biomolecular material. Generally, a biomolecule may be present on a surface area of a biomolecular material and/or a porous material of the biomolecular material from about 0.01% to about 100% of the surface area of the biomolecular material and/or the porous material of the biomolecular material. For instance, a biomolecule may be present on about 0.01% or more, such as about 0.1% or more, such as about 1% or more, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less, of the surface area of a biomolecular material and/or a porous material of a biomolecular material. In some aspects, one type of biomolecule (e.g., enzyme) may be present on a surface area of a biomolecular material and/or a porous material of the biomolecular material in any of the aforementioned percentages, while another, different type of biomolecule is present on another, different surface area of the biomolecular material and/or the porous material of the biomolecular material in any of the aforementioned percentages. For instance, an enzyme may be present on 10% of the surface area of a biomolecular material and/or a porous material of the biomolecular material while a carbohydrate is present on 15% of the surface area of a biomolecular material and/or a porous material of the biomolecular material. In some aspects, two or more of the same type of biomolecule may be present on a biomolecular material and/or a porous material of the biomolecular material. For instance, two or more different enzymes may be present on a surface area of a biomolecular material and/or a porous material of the biomolecular material.

Generally, a biomolecular material and/or a porous material of a biomolecular material may have a selectively chosen bulk density. For instance, a biomolecular material and/or a porous material of a biomolecular material may have a bulk density of from about 0.1 g/cc to about 2 g/cc, including all increments of 0.1 g/cc therebetween. For instance, a biomolecular material and/or a porous material of a biomolecular material may have a bulk density of about 0.1 g/cc or more, such as about 0.2 g/cc or more, such as about 0.4 g/cc or more, such as about 0.6 g/cc or more, such as about 0.8 g/cc or more, such as about 1 g/cc or more, such as about 1.2 g/cc or more, such as about 1.4 g/cc or more, such as about 1.6 g/cc or more, such as about 1.8 g/cc or more, such as about 2 g/cc or less, such as about 1.8 g/cc or less, such as about 1.6 g/cc or less, such as about 1.4 g/cc or less, such as about 1.2 g/cc or less, such as about 1 g/cc or less, such as about 0.8 g/cc or less, such as about 0.6 g/cc or less, such as about 0.4 g/cc or less, such as about 0.2 g/cc or less.

Generally, a biomolecular material and/or a porous material of a biomolecular material may have a selectively chosen surface area (e.g., BET surface area). For instance, a biomolecular material and/or a porous material of a biomolecular material may have a surface area of from about 0.1 m²/g to about 100 m²/g, including all increments of 0.1 m²/g therebetween. For instance, a biomolecular material and/or a porous material of a biomolecular material may have a surface area of about 0.1 m²/g or more, such as about 0.2 m²/g or more, such as about 0.4 m²/g or more, such as about 0.6 m²/g or more, such as about 0.8 m²/g or more, such as about 1 m²/g or more, such as about 2 m²/g or more, such as about 5 m²/g or more, such as about 10 m²/g or more, such as about 20 m²/g or more, such as about 50 m²/g or more, such as about 100 m²/g or less, such as about 50 m²/g or less, such as about 20 m²/g or less, such as about 10 m²/g or less, such as about 5 m²/g or less, such as about 2 m²/g or less, such as about 1 m²/g or less, such as about 0.8 m²/g or less, such as about 0.6 m²/g or less, such as about 0.4 m²/g or less, such as about 0.2 m²/g or less.

Generally, a biomolecular material and/or a porous material of a biomolecular material may have any shape and size. In general, a biomolecular material and/or a porous material of a biomolecular material may be in the form of an aggregate, i.e., a plurality of individual pieces. A biomolecular material and/or a porous material of the biomolecular material may have a cross-sectional size from about 1 millimeter to about 50 millimeters, including all increments of 1 millimeter therebetween. For instance, a biomolecular material and/or a porous material of the biomolecular material may have a cross-sectional size of about 1 millimeter or more, such as about 2 millimeters or more, such as about 5 millimeters or more, such as about 10 millimeters or more, such as about 15 millimeters or more, such as about 20 millimeters or more, such as about 25 millimeters or more, such as about 30 millimeters or more, such as about 35 millimeters or more, such as about 40 millimeters or more, such as about 45 millimeters or more, such as about 50 millimeters or less, such as about 45 millimeters or less, such as about 40 millimeters or less, such as about 35 millimeters or less, such as about 30 millimeters or less, such as about 25 millimeters or less, such as about 20 millimeters or less, such as about 15 millimeters or less, such as about 10 millimeters or less, such as about 5 millimeters or less, such as about 2 millimeters or less.

In one aspect, one or more biomolecules may be applied to a porous material (e.g., glass-based porous material) by various methods. For instance, in one aspect, a biomolecule may be sprayed on a porous material. In this respect, a biomolecule may be combined with an aqueous composition (e.g., water) to form a biomolecular solution that is sprayed on a porous material. Notably, a biomolecular solution may comprise one or more biomolecules and an aqueous composition. In general, a sprayer or nebulizer may be utilized to spray a biomolecular solution on a porous material. A sprayer or nebulizer may generate droplets and/or a mist of the biomolecular solution that is applied to a porous material. In another aspect, a porous material may be dip-coated in a biomolecular solution. In this respect, an aqueous composition may be combined with a biomolecule in a container to form a biomolecular solution. Then, a porous material may be dipped into the biomolecular solution such that at least a portion of the surface of the porous material contacts the biomolecular solution such that a biomolecule and/or a portion of the biomolecular solution adheres and/or is retained on the portion of the porous material that contacts the biomolecular solution. In yet another aspect, the porous material may be spin-coated in a biomolecular solution. In this respect, a selectively chosen amount of a biomolecular solution is deposited on the porous material. Then, the porous material may be spun at high speed to spread the biomolecular solution over at least a portion of the surface of the porous material. In yet a further aspect, a biomolecular solution may be applied to a porous material via printing, such as inkjet printing and/or microprinting. In this respect, in one aspect, a biomolecule and/or a biomolecular solution may be loaded into an inkjet cartridge. Then, droplets of the biomolecule and/or the biomolecular solution may be applied to the surface of the porous material via an inkjet printer. In another aspect, when microprinting is utilized, a stamp and/or mold may be coated with a biomolecule and/or a biomolecular solution. Next, the stamp and/or mold may be pressed against a surface of the porous material to impart and/or transfer the biomolecule and/or a biomolecular solution to the porous material. Notably, inkjet printing and microprinting may allow for the application of a biomolecule and/or a biomolecular solution in a selectively chosen pattern and/or shape to a porous material. Further, inkjet printing and microprinting may allow for the application of a biomolecule and/or a biomolecular solution over a selectively chosen surface area of a porous material. In yet another further aspect, a biomolecular solution containing a biomolecule may be applied to a porous material via a pipette or dropper.

In general, a biomolecular solution may include an aqueous composition (e.g., water) in an amount from about 0 wt. % to about 100 wt. %, including all increments of 1 wt. % therebetween. For instance, a biomolecular solution may include an aqueous composition in an amount of about 0 wt. % or more, such as about 5 wt. % or more, such as about 10 wt. % or more, such as about 20 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 90 wt. % or more, such as about 100 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 10 wt. % or less, such as about 5 wt. % or less by weight of the biomolecular solution.

In some aspects, one or more biomolecules may undergo lyophilization after being applied to a biomolecular material and/or a porous material of a biomolecular material. In general, the lyophilization process can encompass any suitable lyophilization process including, but not limited to, treatment of 10% glycerin, flash-freezing below the eutectic point of the sample (e.g., at −80° C.), and freeze drying. However, a biomolecule may benefit from a more modified process, e.g., a rapid lyophilization method or preservation using dimethyl sulfoxide, as is generally known in the art.

In general, a biomolecular material and/or a porous material of a biomolecular material, including a biomolecular solution applied thereto, may undergo a lyophilization process. In general, one or more biomolecules may be combined with an aqueous composition to form a biomolecular solution. Next, the biomolecular solution may be applied to a biomolecular material and/or a porous material of a biomolecular material. Then, the biomolecular material and/or a porous material of a biomolecular material, including the biomolecular solution applied to the biomolecular material and/or a porous material of a biomolecular material, may be frozen to a temperature below the eutectic point of the biomolecular solution. Notably, a freezer or liquid nitrogen may be utilized to freeze the biomolecular material and/or a porous material of a biomolecular material below the eutectic point of the biomolecular solution. Then, the biomolecular material and/or a porous material of a biomolecular material may be placed in a container, such as a bell jar. Next, the biomolecular material and/or a porous material of a biomolecular material may be subjected to a vacuum by a vacuum system. Next, a condenser system, such as one or more condenser plates, may be positioned in the container and set to a specific temperature or temperature range. Generally, the condenser system may be positioned in the container before, after, and/or during any of the process steps disclosed herein. Notably, the condenser system may provide a surface(s) for a gas and/or vapor (e.g., water vapor) to condense and/or solidify. Next, the frozen liquid (e.g., water) of the biomolecular solution may be removed from the biomolecular material and/or the porous material of a biomolecular material by sublimation while under vacuum. Notably, the vacuum system may remove at least a portion of the sublimated gas during sublimation. Then, any remaining frozen liquid of the biomolecular solution applied to the biomolecular material and/or the porous material of the biomolecular material may be removed by desorption while under vacuum. Next, the biomolecular material and/or a porous material of a biomolecular material may be allowed to dry, such as for a period of 1 hour to about 6 hours, including all increments of one minute therebetween.

Notably, a portion (e.g., any of the steps of the process disclosed herein) or the entirety of the process disclosed herein may occur at atmospheric conditions or under vacuum. For instance, the application of one or more biomolecules to a biomolecular material and/or a porous material of a biomolecular material may occur at atmospheric conditions or under vacuum. Further, for instance, the lyophilization process may occur at atmospheric conditions or under vacuum. In general, any of the process steps disclosed herein may occur at a pressure from about 0.0001 MPa to about 1 MPa, including all increments of 0.0001 MPa therebetween. For instance, any of the process steps disclosed herein may occur at a pressure of about 0.0001 MPa or more, such as about 0.001 MPa or more, such as about 0.005 MPa or more, such as about 0.01 MPa or more, such as about 0.05 MPa or more, such as about 0.1 MPa or more, such as about 0.15 MPa or more, such as about 0.2 MPa or more, such as about 0.4 MPa or more, such as about 0.6 MPa or more, such as about 0.8 MPa or more, such as about 1 MPa or less, such as about 0.8 MPa or less, such as about 0.6 MPa or less, such as about 0.4 MPa or less, such as about 0.2 MPa or less, such as about 0.15 MPa or less, such as about 0.1 MPa or less, such as about 0.05 MPa or less, such as about 0.01 MPa or less, such as about 0.005 MPa or less. In one aspect, the application of a biomolecule to a biomolecular material and/or a porous material of a biomolecular material may occur at one or more of the aforementioned pressures or pressure ranges. Further, for instance, the lyophilization process, including any steps thereof, may occur at one or more of the aforementioned pressures or pressure ranges.

In one aspect, any of the process steps disclosed herein may occur at a lower pressure than those previously disclosed. For instance, any of the process steps disclosed herein (e.g., sublimation) may occur at a pressure of about 0.1 mbar or less, such as about 0.08 mbar or less, such as about 0.06 mbar or less, such as about 0.05 mbar or less, such as about 0.04 mbar or less, such as about 0.02 mbar or less, such as about 0 mbar or more.

In one aspect, the condenser system, such as one or more condenser plates, may have a temperature from about −10° C. to about −70° C., including all increments of 1° C. therebetween. For instance, the condenser system may have a temperature of about −10° C. or less, such as about −20° C. or less, such as about −30° C. or less, such as about −40° C. or less, such as about −50° C. or less, such as about −60° C. or less, such as about −70° C. or more, such as about −60° C. or more, such as about −50° C. or more, such as about −40° C. or more, such as about −30° C. or more, such as about −20° C. or more.

In one aspect, the biomolecular material and/or the porous material of the biomolecular material may undergo sublimation for a period of 12 hours to about 120 hours, including all increments of one minute therebetween. For instance, the biomolecular material and/or the porous material of the biomolecular material may undergo sublimation for a period of about 12 hours or more, such as about 20 hours or more, such as about 40 hours or more, such as about 60 hours or more, such as about 72 hours or more, such as about 120 hours or less, such as about 72 hours or less, such as about 60 hours or less, such as about 40 hours or less, such as about 20 hours or less. It should be understood that the biomolecular material and/or the porous material of the biomolecular material may undergo sublimation for a period less than or greater than the time periods previously disclosed herein.

After undergoing lyophilization, the water content of the biomolecular solution, which is generally in the form of a coating, on the biomolecular material may be from about 0 wt. % to about 10 wt. %, including all increments of 0.01 wt. % therebetween. For instance, the water content of the biomolecular solution on the biomolecular material may be about 0 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 7 wt. % or more, such as about 8 wt. % or more, such as about 9 wt. % or more, such as about 10 wt. % or less, such as about 9 wt. % or less, such as about 8 wt. % or less, such as about 7 wt. % or less, such as about 6 wt. % or less, such as about 5 wt. % or less, such as about 4 wt. % or less, such as about 2 wt. % or less, such as about 1 wt. % or less, such as about 0.5 wt. % or less, such as about 0.1 wt. % or less by weight of the biomolecular solution.

Prior to lyophilizing, nutrients (nitrogen (N), phosphorous (P), carbon (C), or other key minerals) may be added to the materials for specific applications as an amendment. For example, in an oil-contaminated environment with high carbon content, a preparation with added N and P may be advantageous. Such amendments can be easily added on or with the biomolecular material and can be application (e.g., site) specific.

In some aspects, one or more biomolecules may be lyophilized in layers. In this respect, a first biomolecular solution may be applied to at least a portion of a biomolecular material and/or a porous material of a biomolecular material and lyophilized. After the first biomolecular solution is lyophilized, a second biomolecular solution may be applied to at least a portion of the biomolecular material and lyophilized. Generally, at least a portion of one or more layers formed by one or more biomolecules may be layered on top of one another and/or overlap. For instance, in one aspect, a first biomolecular solution may be applied to at least a portion of a biomolecular material and/or a porous material of a biomolecular material and lyophilized. Then, a second biomolecular solution may be applied to at least a portion of the biomolecular material and lyophilized such that at least a portion of the layer formed by one or more biomolecules of the second biomolecular solution may be layered on top of and/or overlap with the layer formed by one or more biomolecules of the first biomolecular solution. In another aspect, a plurality of biomolecular solutions may be applied to at least a portion of a biomolecular material and/or a porous material of a biomolecular material and then lyophilized. In general, the biomolecular material may have one or more lyophilized layers comprising one or more biomolecules, such as two lyophilized layers. Notably, any number of biomolecular solutions may be utilized to form any number of lyophilized layers.

In general, the biomolecular materials including the lyophilized one or more biomolecules thereon can be stored as desired, e.g., up to several months or more. Beneficially, the storage environment does not require any specialized environmental conditions. For instance, the materials can be stored in air at standard temperature (e.g., 20° C.) and pressure conditions (e.g., 1 atm). The biomolecular materials can likewise be shipped and deployed without the need for any specialized environmental conditions. For instance, the biomolecular materials need not be subjected to laboratory processing to revitalize the preserved one or more biomolecules. In many embodiments, the biomolecular materials can simply be located in the deployment area, following which the retained one or more biomolecules may be activated. The biomolecular material disclosed herein may be particularly beneficial in applications including those in the oil, gas, and mining industry, agricultural applications, wastewater treatment systems, defense contractors, biotechnology, and bioremediation projects where effective delivery of active biomolecules is critical. In one aspect, a biomolecular material formed in accordance with the present disclosure may float on a liquid (e.g., oil, water). In another, aspect, a biomolecular material formed in accordance with the present disclosure may sink in a liquid (e.g., oil, water). A biomolecular material formed in accordance with the present disclosure may be particularly applicable to clean oil spills and/or algae blooms.

### EXAMPLES

Glass-based porous materials were treated with a biomolecular solution to form biomolecular materials comprising biomolecules.

Each of the biomolecular materials were prepared according to the following process. For each of the biomolecular materials, one or more biomolecules were combined with water to form a biomolecular solution. Next, the biomolecular solution was applied to a glass-based porous material. Then, the glass-based porous material, including the biomolecular solution applied to the glass-based porous material, was frozen to a temperature below the eutectic point of the biomolecular solution. Then, the glass-based porous material was placed in a bell jar. Next, the glass-based porous material was subjected to a vacuum of 0.04 mbar or less by a vacuum system. Additionally, a condenser system was positioned in the bell jar and set to −40° C. Next, the frozen water of the biomolecular solution was removed from the glass-based porous material by sublimation while under vacuum for a period of about 24 hours. Then, the samples were allowed to dry for an additional 3 to 4 hours.

### Example 1

In Example 1, a glass-based porous material was treated with a biomolecular solution comprising kanamycin sulfate, an aminoglycoside antibiotic. Next, the glass-based porous material that was treated with the kanamycin sulfate was lyophilized. The biomolecular material was then applied to a streak plate of E. coli K-12. The kanamycin sulfate formed a zone of inhibition around the biomolecular material indicating that the kanamycin sulfate survived the process and was still active on the surface of the biomolecular material.

### Example 2

In Example 2, a glass-based porous material was treated with a biomolecular solution comprising bovine serum albumin. Next, the glass-based porous material that was treated with the bovine serum albumin was lyophilized. The biomolecular material was then tested via a Bradford protein assay, which indicated that the bovine serum albumin survived the process and was still active on the surface of the biomolecular material.

### Example 3

In Example 3, a glass-based porous material was treated with a biomolecular solution comprising soybean oil, which is a plant-based mixture including triglycerides. Next, the glass-based porous material that was treated with the soybean oil was lyophilized. The biomolecular material was then tested via an ethanol emulsion test, which indicated that the triglycerides, in addition to other lipids, of the soybean oil survived the process and were still active on the surface of the biomolecular material.

### Example 4

In Example 4, a glass-based porous material was treated with a biomolecular solution comprising catalase. Next, the glass-based porous material that was treated with the catalase was lyophilized. The biomolecular material was then tested using a 3% hydrogen peroxide solution. Notably, catalase generally reacts with hydrogen peroxide to form oxygen and water. Oxygen and water were formed when the biomolecular material was tested using the 3% hydrogen peroxide solution, which indicated that the catalase survived the process and was still active on the surface of the biomolecular material.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims

1. A biomolecular material comprising:
a porous material, the porous material being in the form of a solid, the porous material comprising a surface, wherein at least a portion of the surface of the porous material is a substrate; and
one or more biomolecules, wherein the one or more biomolecules are retained on the substrate, wherein at least one biomolecule of the one or more biomolecules is lyophilized.

2. The biomolecular material of claim 1, wherein the porous material comprises a glass-based porous material.

3. The biomolecular material of claim 1, wherein the porous material comprises crystalline components and vitreous components.

4. The biomolecular material of claim 1, wherein the porous material comprises an engineered cellular magmatic.

5. The biomolecular material of claim 1, wherein the one or more biomolecules are present on a surface area of the biomolecular material in an amount from about 0.01% to about 100%.

6. The biomolecular material of claim 1, wherein the biomolecular material has a bulk density from about 0.1 g/cc to about 2 g/cc.

7. The biomolecular material of claim 1, wherein the biomolecular material has a surface area from about 0.1 m²/g to about 100 m²/g.

8. The biomolecular material of claim 1, wherein the one or more biomolecules comprise one or more proteins.

9. The biomolecular material of claim 1, wherein the one or more biomolecules comprise one or more lipids.

10. The biomolecular material of claim 1, wherein the one or more biomolecules are applied to the porous material in the form of a biomolecular solution before the at least one biomolecule of the one or more biomolecules is lyophilized.

11. A method for forming a biomolecular material, the method comprising:
applying one or more biomolecules to a porous material, the porous material being in the form of a solid, the porous material comprising a surface, wherein at least a portion of the surface of the porous material is a substrate; and
lyophilizing the one or more biomolecules to form a biomolecular material, wherein the one or more lyophilized biomolecules are retained on the substrate.

12. The method of claim 11, wherein the porous material comprises a glass-based porous material.

13. The method of claim 11, wherein the porous material comprises crystalline components and vitreous components.

14. The method of claim 11, wherein the porous material comprises an engineered cellular magmatic.

15. The method of claim 11, wherein the one or more biomolecules are present on a surface area of the biomolecular material in an amount from about 0.01% to about 100%.

16. The method of claim 11, wherein the biomolecular material has a bulk density from about 0.1 g/cc to about 2 g/cc.

17. The method of claim 11, wherein the biomolecular material has a surface area from about 0.1 m²/g to about 100 m²/g.

18. The method of claim 11, further comprising combining an aqueous composition with the one or more biomolecules before the one or more biomolecules are applied to the porous material.

19. The method of claim 11, further comprising storing and/or transporting the biomolecular material to a site; and
deploying the biomolecular material at the site.

20. The method of claim 19, wherein the biomolecular material is stored and/or transported at standard pressure conditions.
